(19) United States
(12) Patent Application Publication
(10) Pub. No.: US 2004/0134980 A1
(43) Pub. Date: Jul. 15, 2004

(54) Scaleable locking

(76) Inventors: Dennis Flood, Dundee (GB); James Boyes, Blairgowrie (GB)

Correspondence Address: MICHAEL CHAN, NCR CORPORATION, 1700 SOUTH PATTERSON BLVD, DAYTON, OH, 45479-0001, US

(21) Appl. No.: 10/717,882

(22) Filed: Nov. 20, 2003

(30) Foreign Application Priority Data
Dec. 2, 2002 (GB) 0227991.7

(51) Int. Cl. G06F 17/60; G06F 7/08

(52) U.S. Cl. 235/379; 235/381

(57) ABSTRACT

An automated teller machine (10) having a secure enclosure (26); a lock (30) for securing the secure enclosure (26) and a processor (24) for controlling teller machine functionality and additionally the lock (30).

### BACKGROUND OF THE INVENTION

The present invention relates to a locking arrangement for a secure enclosure, and in particular a locking arrangement for a self-service terminal, such as an automated teller machine.

Automated teller machines use a variety of conventional high security safe locks, for example, conventional three wheel high security locks that need a three wheel combination to be opened. These three wheel locks are, however, difficult to open, even with practice. This can cause serious security problems. In addition, often the lock wheels are not fully spun on closing, so the lock can be re-opened without having to dial up the three wheel combination. Furthermore, it can be difficult to change the combinations for these locks, so they can remain set on the same combination number for years. In a bank environment dozens of people get to know this potentially lucrative opening number. Clearly, this is a security risk.

Other locks that are in common usage are electronic keypad combination locks. An advantage of these is that they can be re-programmed so that the combination number can be altered as and when desired. This solves the usability aspect. However, even the cheapest of these locks is around three times the cost of a mechanical lock. Much of this cost is because of the electronics and processors that have to be embedded in the lock to give the necessary intelligence to activate the locking mechanism.

Another more recent lock is the so-called audit trail lock. This includes a processor that can be programmed using a series of unique personal identification numbers (PINs) to identify who entered the safe; when they entered; when they exited; whether they gave the correct daily cash in transit (CIT) code, and whether they gave the correct exit code. The use of a 500-event memory has become commonplace in this type of lock. This has proven to be an invaluable tool to prevent “shrinkage” of cash, especially for the CIT industry. The lock can be interrogated at the safe by using, for example, dedicated hardware, such as printers, to download audit trail information from the lock. The main drawback with these audit trail locks is the price, which can be more than ten times the cost of a conventional lock. In addition, the best of them need a complete infrastructure and special hardware to allow auditing and monitoring of risky sites.

### SUMMARY OF THE INVENTION

An object of the invention is to provide an improved lock for use in secure enclosures, in particular for use in self-service machines, such as automated teller machines.

According to one aspect of the present invention, there is provided a device or machine, such as self-service machine, for example an automated teller machine, the device or machine having a secure enclosure; a lock for securing the secure enclosure and a controller, for example a processor, for controlling device or machine functionality and additionally the lock.

As part of its inherent intelligent capabilities at delivering cash and related services to the public, the modem ATM has a processing ability that can far outstrip the best lock processing for top-of-the-range electronic audit trail locks. By using this processing capability to control both the teller machine functionality and additionally a lock, a simple lock can be made to operate in a manner that surpasses the capabilities of audit trail locks.

Preferably, the controller/processor is connected to the lock via a secure communications link. For example, the controller/processor may be operable to generate encrypted control commands for sending to a decryptor in the secure enclosure, wherein the decryptor is operable to decrypt the control command and pass the decrypted command to the lock.

Preferably, the lock is an electronic solenoid lock.

A detector may be provided for detecting tampering with the safe. The detector may be operable to send an alarm signal to the controller/processor when tampering is detected.

A spoiler mechanism actuatable in response to a control signal from the controller/processor may be provided. The spoiler mechanism is operable to cause damage to the contents of the secure enclosure in the event that tampering is detected. The spoiler mechanism may be operable to spray fluid over the contents of the secure enclosure. The fluid may be such as to render the contents of the secure enclosure unusable. For example, the fluid may be paint.

According to another aspect of the present invention, there is provided a system for controlling a device or machine, such as a self-service machine, for example an automated teller machine, the device or machine having a secure enclosure that is securable using a lock, the system comprising controller, for example a processor, that is adapted or configured to control device or machine functionality and additionally the lock. The controller may be provided in the device or machine or may be provided separately or remotely therefrom.

According to yet another aspect of the present invention, there is provided a controller for controlling a device or machine, such as a self-service machine, for example an automated teller machine, the device or machine having a secure enclosure that is securable using a lock, the controller, for example a processor, being adapted or configured to control device or machine functionality and additionally the lock. The controller may be provided in the device or machine or may be provided separately or remotely therefrom.

According to still another aspect of the invention, there is provided a computer program, preferably on a data carrier or a computer readable medium, for controlling a device or machine, such as a self-service machine, for example an automated teller machine, the device or machine having a secure enclosure that is securable using a lock, the computer program having code or instructions for controlling device or machine functionality and additionally the lock.

### BRIEF DESCRIPTION OF THE DRAWING

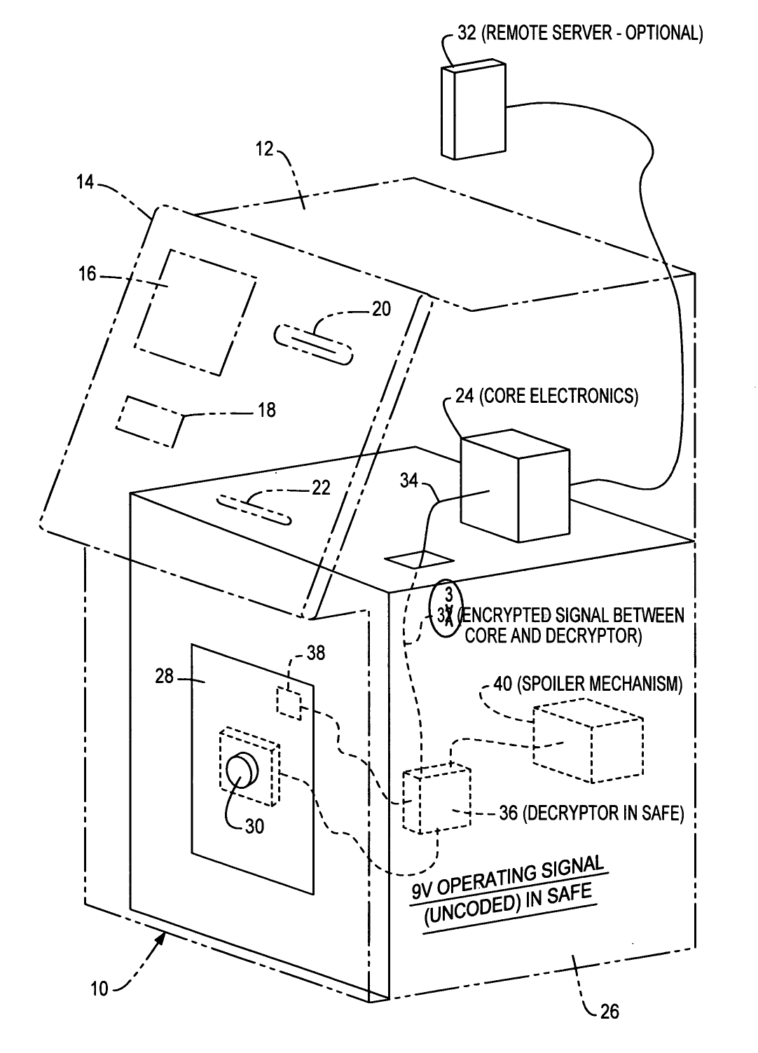

An automated teller machine in which the invention is embodied will now be described with reference to FIG. 1, which is a diagrammatic representation of an automated teller machine.

### DETAILED DESCRIPTION

FIG. 1 shows an ATM 10 that has an outer housing 12, with a front fascia 14 having a screen 16 for presenting information to a user, a keypad 18 for receiving user inputs, a slot 20 for receiving a magnetic card and a dispenser slot 22 through which money from a dispenser mechanism (not shown) is dispensed. Also provided is a transfer mechanism (not shown) for transferring a card entered into the slot 20 to a card reader (not shown). Connected to the screen 16, the keypad 18 and the card reader is a core module 24. This is provided in the housing 12, together with a safe 26 for storing money that is to be dispensed from the ATM. The safe 26 has a door 28 that is lockable using an electronic solenoid lock 30. The door 28 of the safe 26 is only opened when the ATM has to be replenished with money.

The core module 24 may be implemented in hardware or using a computer program. It is operable to control the overall ATM functionality, such as reading and interpreting magnetic cards inserted into the housing 12 and receiving and acting on user inputs. The core 24 is also optionally connected to a central server 32, so that remote control and/or inspection and/or interrogation of the ATM are possible. All of this is standard. However, in addition to this, the core electronics module 24 is adapted to control the electronic lock 30. In particular, the core module 24 is operable to cause the lock 30 to be released so that the safe door 28 can be opened. The core module 24 is also operable to cause the lock 30 to be secured, when the door is closed. Of course, it will be appreciated that this may not always be necessary, because many locks can be automatically activated when the door is closed.

In order to ensure the integrity of the communication channel, the core electronics module 24 is connected to the lock 30 via a secure link 32. This secure link 32 includes an encryptor that is implemented in the core electronics 24, some form of cable 34 and a decryptor 36 that resides within the safe 26. All control signals sent to the lock 30 from the core module 24 are encrypted and passed to the decryptor 36. Hence, even although the processing core 24 is placed outside the safe 26, there is no associated security risk. No one tapping the signals from the core 24 would be able to break into the line 32 and mimic the signals needed to open the lock.

Any suitable encryption technique could be used to encrypt the command signals for the lock 30. In particular, any of the encryption standards that are already in existence for financial and other institutions could be used.

The ATM 10 is adapted to control the lock 30 in response to user inputs. These can be received from the keypad 18 or the remote server-32 or an enhanced operator panel (EOP) (not shown), which is typically provided separately from the user keypad 18 on the front fascia 14. For high security environments, this option may necessitate encrypting the communication lines to the keypad 18 and EOP module. Such encryption is already commonplace for customer inputs such as keyboards, and so will not be described herein in detail.

In order for the core module 24 to implement audit trail functionality, each authorized user, for example, the service personnel who refill the safe 26, is allocated a unique personal identification number (PIN) or combination number. This information is stored in an access control file. To open the safe 26, a PIN number has to be input to the core module 24, where it is checked against the list of authorized numbers in the control access file. In the event that the number entered is not on the list, the core module 24 does not send an activation signal to the lock 30. In contrast, if the number entered is on the list, the core module 24 generates and sends an appropriately encrypted signal to the decryptor 36, which decrypts the message and sends a control signal to open the lock 30.

Each time a PIN is accepted and a command signal is generated and sent, the core module 24 records the PIN entered in a suitable log, together with the time at which it was entered. In this way, by subsequently referring to the log, it is possible to uniquely identify who opened the lock and when.

The data for access control, that is the list of authorized PINs, and audit trail log could be stored within the core 24. Alternatively, the data could be stored or maintained in the remote server 32 and transferred in real time between the server 32 and the core 24 as and when desired.

The list of authorized PINs could be updated manually by service personnel at each ATM. Alternatively, when the ATM 10 is connected to a remote server 32, the data could be up-dated remotely by server 32.

The lock 30 itself could be a solenoid device with, for example a 9V input to drive the lock. It would be easy to downgrade existing electronic locks to provide a suitable lock to do this cheaply. Electronic solenoid locks have a lockbolt. This is used to secure the safe door closed. By enabling the solenoid using a control signal from the core module 24, the lockbolt can be moved to an open position. To allow this, the lock could have a simple handle to withdraw the lockbolt, once the lock's solenoid had been enabled. Alternatively the lock could be made with no handle at all, and the lockbolt could be withdrawn automatically when the solenoid is enabled. In either case, the solenoid of the lock firstly has to be enabled by an appropriate control signal from the core 24.

In order to provide additional security, a detector 38 may be provided in association with the lock 30 and/or the door 28 of the safe 26 for detecting tampering with the safe 26. The detector 38 is connected to the core module 24 via the secure link 32 and is operable to send an alarm signal thereto when tampering is detected. In this case, it should be noted that a safe encryptor is provided for encrypting messages from the detector 38 to the core 24. This could be provided separately or as part of the safe decryptor module 36. In the event that tampering is detected, the detector 38 is operable to generate an alarm signal. This is sent to the safe encryptor, where it is encrypted and forwarded to the core processor 24. Once received at the core 24, the signal is decrypted and recognized as being an alarm. The core 24 may then activate an audible alarm. Alternatively, when the ATM 10 is networked, the core 24 may generate an alarm signal and send it to the remote server 32, where appropriate action can be taken. In this way, the system can be adapted to provide a so-called silent alarm.

As a further security measure, a spoiler mechanism 40 may be provided. This is adapted to cause damage to the contents of the safe 26 in the event that tampering is detected. The spoiler mechanism 40 may be operable to spray fluid over the contents of the safe 26. The fluid may be such as to render the contents of the secure enclosure unusable. For example, the fluid may be paint. The spoiler mechanism 40 may be actuatable in response to a control command sent over the secure link 32 from the core module 24. Alternatively, the control command may be generated by the detector 38 and sent directly to the spoiler mechanism 40.

There are various ways in which the ATM 10 in which the invention is embodied could be implemented. In one example, a CIT worker could access the ATM safe 26 using an access level card (not shown) that can be inserted into the card slot 20 and read by the conventional card reader. To do this, the authorized person would be provided with a card and a PIN to give a preliminary identity verification. He could then input the lock combination, possibly together with his own unique lock PIN, either from the lock keypad, or alternatively from the customer keypad or EOP. It should be noted that these latter options mean that there need be no external keypad on the safe door 28 at the lock 30. As mentioned previously, audit trail data concerning times of access and personnel identity could be stored at the ATM, or transmitted immediately to the central server 32. Once the lock 30 is released, the service personnel can replenish the safe 26. After this is done, the safe door 28 is closed and the lock 30 is either manually or automatically moved to its secured position. Once this is done, a signal may be sent to the core 24 to confirm that the safe 26 is again secured.

Because of the extensive processing capabilities of most ATMs, many useful security functions can be simply and efficiently implemented. For example, the core module 24 could set time windows for planned access for particular personnel. This means that access to the safe 26 by authorized personnel can be set so that they are only allowed to open the safe at certain times, e.g. for thirty minutes after bank closing. Alternatively, this time window could be set by the server 32 and downloaded to the core processor 24. As an additional or alternative feature, verification of the person accessing the safe could be done by someone at the central server 32, rather than by the core processor 24. In this way, using the ATM network, there is provided a remote verification capability to allow the safe to be opened.

Whilst in the example shown in FIG. 1, a separate decryptor 36 is mounted adjacent to the lock 30, decryption could be done using a processor associated with or provided as part of the lock 30. However, an advantage of having a separate decryptor 36 is that it makes scalability easier. This is because in a single network the ATMs may use a variety of different locks having different processing needs or requirements. For example a basic keypad lock might need very little decryption or processing whereas a high-end multi-function audit trail lock may permit better encryption/decryption capabilities. By having a separate decryptor all locks in a network can be retrofitted with the lock arrangement in which the invention is embodied, without having to take into account the capabilities of the existing locks. A further advantage of having a separate decryptor is that several locks could be run off it. This could be useful, because two locks are usually used on high security safes.

The present invention has many advantages. It provides a very cheap electronic lock for safes and high security ATM applications, using the extensive processing capabilities of the ATM to become multi-functional. Additionally, it can be scaled up to become a high-end audit trail lock at little extra cost. Furthermore, direct communication with a central server allows remote audit; remote enable; remote user PIN change after preset time; remote user enable/disable; remote monitoring, including lock status, alarm signals etc; remote authentications, including who, what and when; and remote updates. For example, the remote server could up-date allowable time windows for opening, remote enabling of new authorized personnel at the ATM, and totally remote locking. In addition, it is easy to program in time delays, an anti-hold-up alarm, that is a silent alarm, dual access codes, and verification codes that are indicative of task completion by CIT or serviceman. Furthermore, the arrangement provides for the control of two or more locks via one processing and encryption package.

Using the ATM in-built processing capability means that the bank does not need to manage a network for the ATMs controlled at the server, and an additional, separate network controlled by their CIT and servicing organizations. Furthermore, using existing, in-built processing capability means that the lock can incorporate most audit trail and high security lock functions available today, at a fraction of the cost. As well as this it can be used as an intelligent hub to monitor and distribute alarm signals and can be used as the initiator for spoiling/degradation devices in the event of intrusion. Furthermore, no special hardware is needed for print-outs of any audit trail information, instead the standard ATM printer can be used.

A skilled person will appreciate that variations of the disclosed arrangements are possible without departing from the invention. For example, whilst the invention has been described with reference to an ATM, it will be appreciated that it could be used in any system that has processing capability that is provided for one function, which processing capability can be extended to be used to control a lock for an associated secure enclosure, such as a safe. For example, the invention may be used in slot machines or vending machines, each of which may include processors for controlling functionality, but also need a secure enclosure for holding money input by users. Accordingly, the above description of a specific embodiment is made by way of example only and not for the purposes of limitation. It will be clear to the skilled person that minor modifications may be made without significant changes to the operation described.

What is claimed is:

1. A self-service machine comprising:
a secure enclosure;
a lock for securing the secure enclosure; and
a controller for controlling machine functionality and additionally the lock.

2. A self-service machine as claimed in claim 1, further comprising a secure communications link interconnecting the lock and the controller.

3. A self-service machine as claimed in claim 2, wherein (i) the secure communications link includes a decryptor that is provided in the secure enclosure, (ii) the controller includes means for encrypting a control command and sending the encrypted command to the decryptor, and (iii) the decryptor includes means for decrypting the control command and passing the decrypted command to the lock.

4. A self-service machine as claimed in claim 1, wherein the lock comprises an electronic solenoid lock.

5. A self-service machine as claimed in claim 1, wherein the controller includes means for sending information relating to the lock to a central processor.

6. A self-service machine as claimed in claim 1, further comprising at least another lock, and wherein the controller includes means for controlling each of the locks.

7. A self-service machine as claimed in claim 1, further comprising a detector for detecting tampering with the secure enclosure.

8. A self-service machine as claimed in claim 7, wherein the detector includes means for sending an alarm signal to the controller when tampering is detected.

9. A self-service machine as claimed in claim 1, further comprising a spoiler mechanism for causing damage to the contents of the secure enclosure.

10. A self-service machine as claimed in claim 9, wherein the spoiler mechanism is actuatable in response to a control signal from the controller.

11. A self-service machine as claimed in claim 10, wherein the spoiler mechanism is actuated when tampering with the lock is detected.

12. A self-service machine as claimed in claim 9, wherein the spoiler mechanism includes means for spraying fluid over the contents of the secure enclosure.

13. An automated teller machine (ATM) comprising:
a safe for storing money to be dispensed during ATM transactions;
a lock for securing the safe; and
an ATM processor for (i) controlling ATM functionality, and (ii) controlling operation of the lock.

14. An ATM according to claim 13, further comprising a secure communications link interconnecting the lock and the ATM processor.

15. An ATM according to claim 14, wherein (i) the secure communications link includes a decryptor that is provided in the safe, (ii) the ATM processor includes means for encrypting a control command and sending the encrypted command to the decryptor, and (iii) the decryptor includes means for decrypting the control command and passing the decrypted command to the lock.

16. An automated teller machine (ATM) comprising:
storage means for storing money to be dispensed during ATM transactions;
securing means for securing the storage means;
controlling means for controlling ATM functionality and operation of the securing means; and
communication means interconnecting the securing means and the controlling means and for enabling the controlling means to control operation of the securing means.

17. A system for use in an automated teller machine (ATM) having a lock and a safe which can be secured with the lock, the system comprising:
an ATM controller for controlling ATM functionality and operation of the lock to secure the safe.

18. A system as claimed in claim 17, further comprising a secure communications link which interconnects the lock and the ATM controller to allow the ATM controller to control operation of the lock.

19. A system as claimed in claim 18, wherein (i) the secure communications link includes a decryptor that is provided in the safe, (ii) the ATM controller includes means for encrypting a control command and sending the encrypted command to the decryptor, and (iii) the decryptor includes means for decrypting the control command and passing the decrypted command to the lock.

20. A program storage medium readable by a computer having a memory, the medium tangibly embodying one or more programs of instructions executable by the computer to perform method steps for controlling a self-service machine having a lock and a secure enclosure that is securable using the lock, the method comprising the steps of:
controlling functionality of the self-service machine; and
controlling operation of the lock.
